(19) United States
(12) Patent Application Publication
(10) Pub. No.: US 2004/0134122 A1
(43) Pub. Date: Jul. 15, 2004

(54) System for arranging a screen above a subsoil

(76) Inventors: Adrianus Cornelius Gabriel Van Bergen-Henegouwen, EM Poeldijk (NL); Hans Jan Pieter Kolk, CD Beringen (NL)

Correspondence Address: OSTROLENK FABER GERB & SOFFEN, 1180 AVENUE OF THE AMERICAS, NEW YORK, NY, 100368403

(21) Appl. No.: 10/484,339

(22) PCT Filed: Jul. 22, 2002
(86) PCT No.: PCT/NL02/00494

(30) Foreign Application Priority Data
Jul. 20, 2001 (NL) 1015603

(51) Int. Cl. A01G 13/02

(52) U.S. Cl. 47/22.1

(57) ABSTRACT

The present invention relates to a system (1) for arranging or removing a screen (2) some distance above a ground, particularly provided with crops (3), comprising: -one or more supports (4) extending at least partly at the distance above the ground, wherein the supports (4) are provided with guide means; -a screen with edge suitable for being guided in or along the guide means (7) of the supports (4); and pulling means (12) which arranged on at least one side of the guide means (7) and which can be mounted releasable on the edge of the screen (2), in order to pull the screen (2) along the supports (4) into a position substantially screening the ground or into a position leaving the ground clear.

The invention relates to horticultural greenhouses provided with front, rear and side outer walls, as well as a transparent roof comprising one or more mutually adjacent panels. These panels are supported by a number of supports which are arranged between the upper ends of vertical columns. If desired, an energy-saving or reflective movable screen is traditionally arranged between said supports which remains present between the supports, high up in the greenhouse, for its entire lifespan, either in folded or rolled-up state (open position) or pulled out or unrolled from support to support (open position). In order to save energy a disposable foil can also be draped over a bed of wires arranged at a height.

Said systems are found to have a number of drawbacks, a number of which are discussed in the following. The arranging and installing of the installation as known according to the prior art is very labour-intensive and can take a number of days. The screen permanently present in the greenhouse, in folded and/or rolled-up state, herein deprives the crops situated thereunder of light, wherein light is an essential factor in the growth of these crops.

Further drawbacks likewise result from the screen being permanently present in the greenhouse. Said screen is for instance difficult to clean when it becomes dirty, since the screen is arranged high up in the greenhouse and the removal and cleaning thereof at ground level is very labour-intensive, which is not cost-effective for economic reasons. As a consequence of damage and fouling of the screen in the longer term, a permanently good closing of the screen, necessary in respect of energy saving, is a problem. UV radiation for instance incident on the screen at the position of the air windows shortens the lifespan of the screen. The folded and/or rolled-up package can herein be a source of infection for diseases. Since the use of the screens is only required under specific conditions, the screen is usually present in the greenhouse in folded or rolled-up state, so that bacteria and/or pathogens can develop easily in this moist and warm environment. The screen permanently present in the greenhouse is also a fire hazard since it is usually manufactured from plastic or other flammable material. Further drawbacks of the present systems such as are usual in greenhouses relate to the user-friendliness of the systems. The screen is thus generally guided from the one support to the other via guide wires, wherein these guide wires are likewise permanently arranged in the greenhouse. However, said wires impede a free passage from the ground level in the direction of the roof of the greenhouse as required during maintenance and/or repair operations on this greenhouse roof, while removal of the guide wires is usually also not possible due to the labour-intensive nature thereof. Replacement of the screen by a screen with different properties, required because of changed conditions, is once again not possible within a few hours due to said labour-intensiveness.

The present invention has for its object to obviate one or more of the above stated or other drawbacks of known systems.

The present invention provides a system for arranging or removing a screen some distance above a ground, particularly provided with crops, comprising:

one or more supports extending at least partly at the distance above the ground, wherein the supports are provided with guide means;

a screen with edge suitable for being guided in or along the guide means of the supports; and

pulling means which are arranged on at least one side of the guide means and which can be mounted releasably on the edge of the screen, in order to pull the screen along the supports into a position substantially screening the ground or into a position leaving the ground clear. Although it is possible to envisage setting up such a system in the open air, a first preferred embodiment relates to a greenhouse or glasshouse incorporating such a system. Owing to the system according to the present invention screens can be readily exchanged and/or cleaned. Particularly in high glasshouses there is no longer the danger of (bodily) injury in such operations, while the cultivation and incidence of light encounter little or no hindrance from such a system.

In a first preferred embodiment the guide means comprise a profile in which an edge of the screen, thickened for instance with a cable, can be guided.

In order to prevent such a screen being pulled out of alignment between two guide means and in order to properly transmit the forces of the pulling means, the edge of the screen comprises bead-like bodies, i.e. substantially cylindrical or other stud-shaped bodies, which engage on bead-like bodies with the same pitch distance of a pull cable or chain, while the wheels of the pull cable for driving are provided with nest-like recesses which, owing to the corresponding form, engage on the bead-like bodies on the pull cable or chain.

Particularly in the case of a large span it is important that the pull cable or chain is strong and has little stretch. A steel cable of predetermined diameter is for instance suitable for this purpose. The advantage of a strong synthetic material cable is a lower weight, while the requirements of strength and stretch can also be met. A chain has a sufficient strength and provides the advantage that weak links can be replaced.

In a further preferred embodiment adjacent wheels are driven via a common shaft in order to synchronize the driving as well as possible.

In the case of a large span and/or application in the open air it may also be important to strengthen the screen, for instance by means of synthetic material wires or even steel wires.

The system according to the present invention preferably also comprises mobile baskets and/or rolls in which the different screens can be stowed and if necessary displaced, for instance prior to being arranged in the greenhouse or the glasshouse or being moved to frameworks above outdoor cultures and fruit crops, wherein in these cultures use is made of placing of wire meshes, foils and cloths, or being immediately removed therefrom just after the whole screen has been removed from the guide means.

In a further preferred embodiment two or more profiles are arranged close together on a common support in order to enable arrangement of different screens one above the other, for instance for retaining heat and blocking light, repelling insects and preventing the entry of moisture.

Further advantages and features of the present invention are elucidated on the basis of the following description of the preferred embodiments thereof, with reference to the annexed drawings, in which:

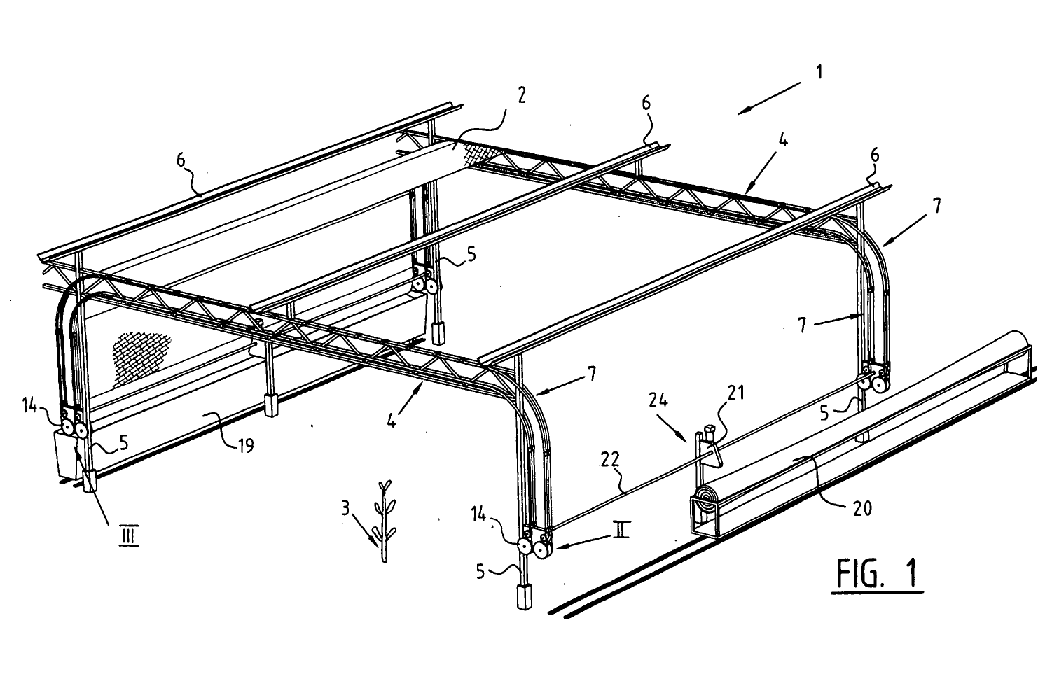

FIG. 1 shows a perspective view of a first preferred embodiment of a system according to the present invention;

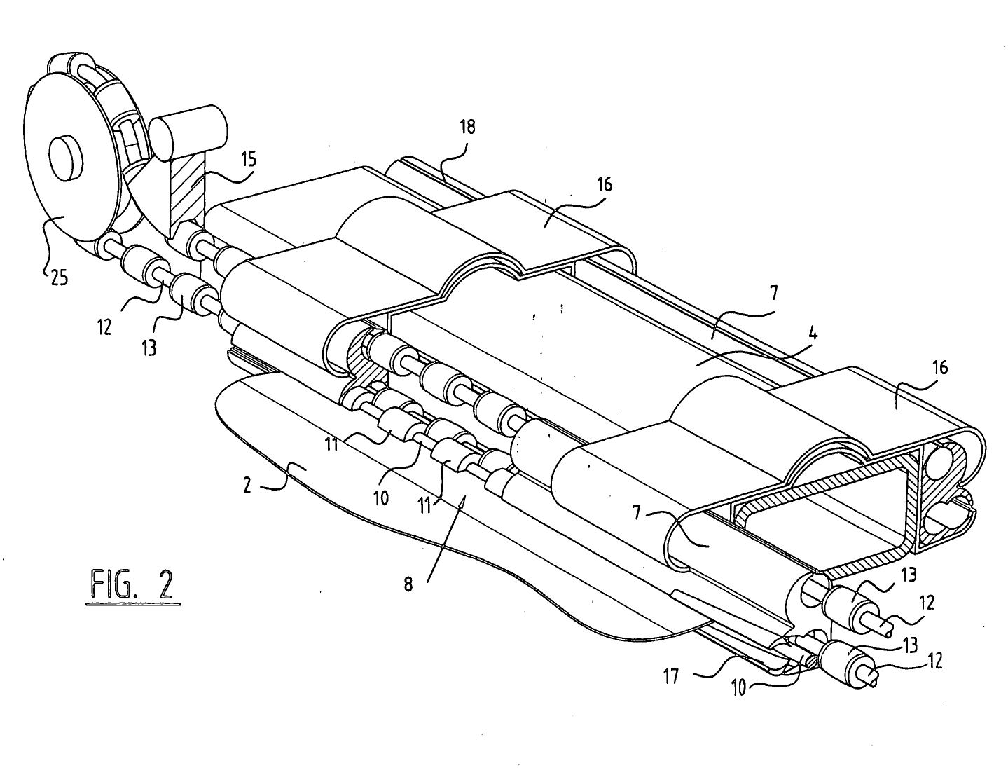

FIG. 2 shows a partly broken-away perspective view of detail II of FIG. 1;

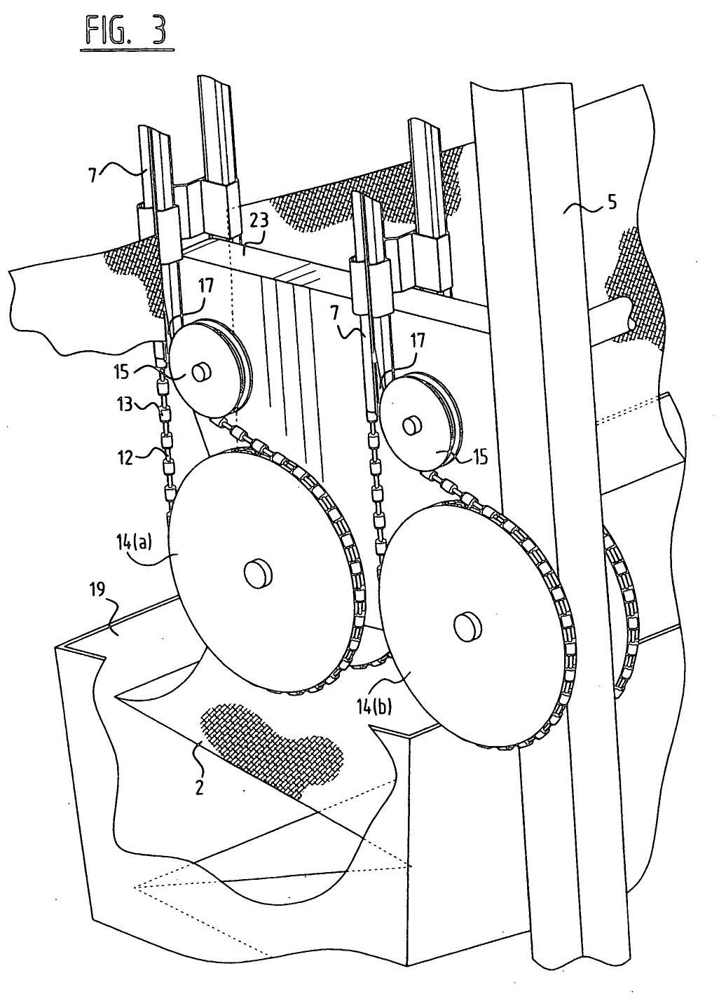

FIG. 3 is a partly broken-away perspective view of detail III of FIG. 1;

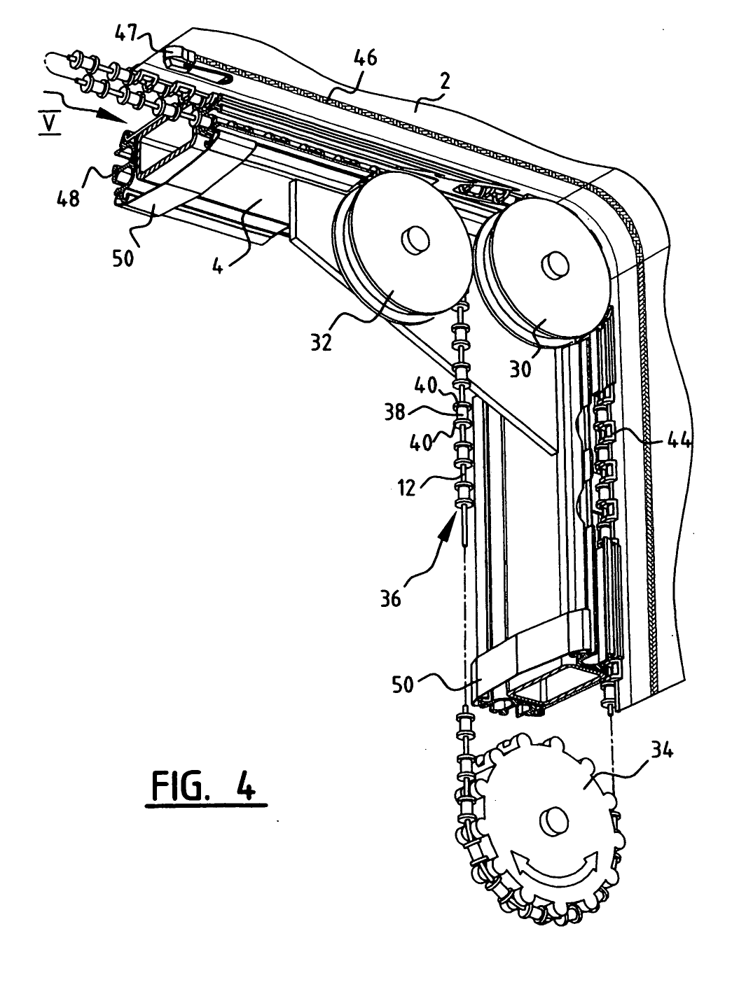

FIG. 4 is a partly broken-away perspective view of a detail in a second preferred embodiment;

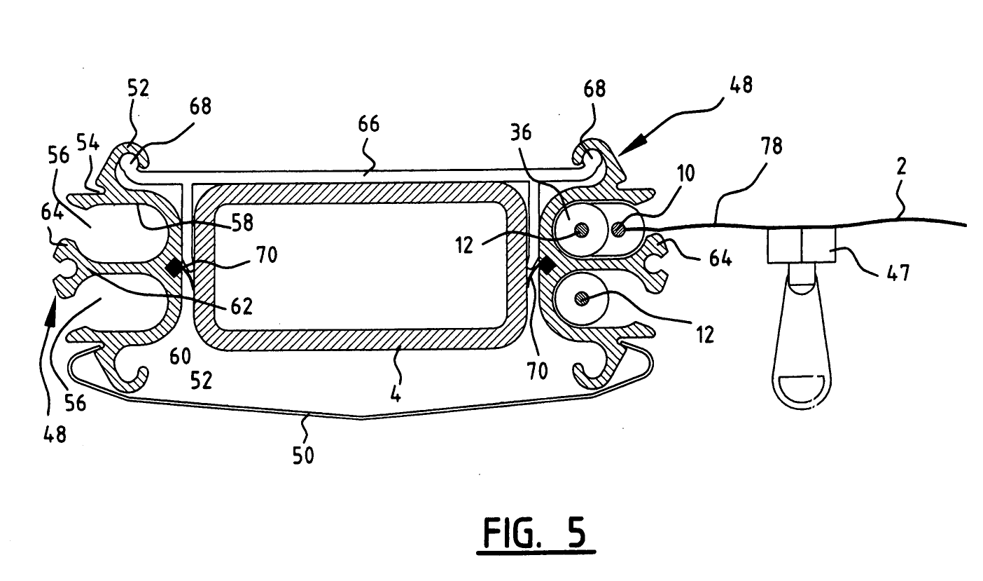

FIG. 5 shows a cross-section of detail V of FIG. 4; and

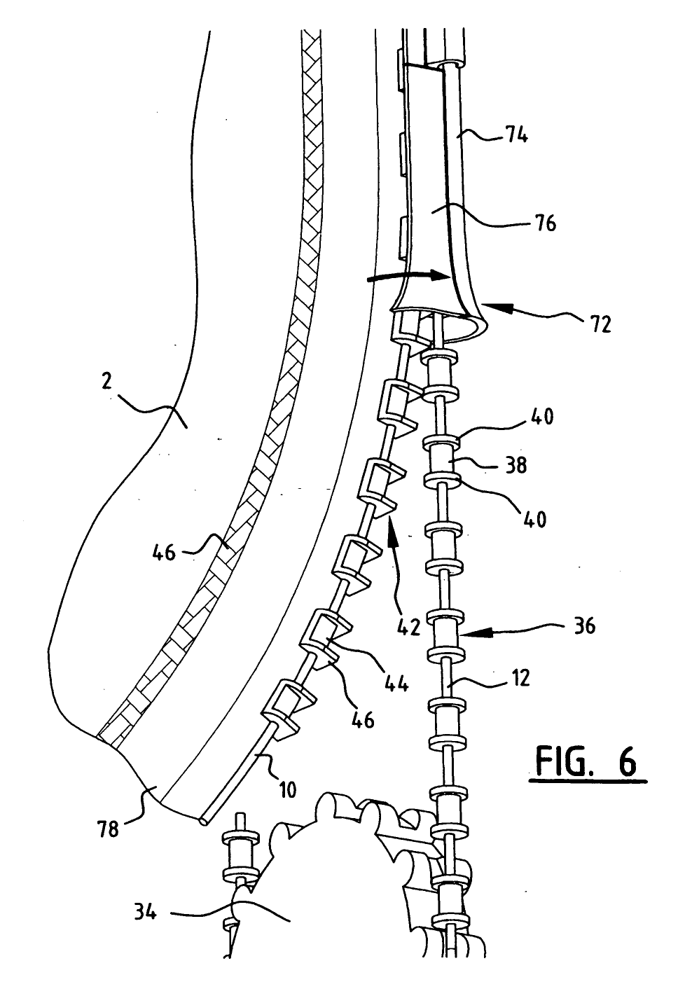

FIG. 6 shows a partly broken-away view of pulling means and a screen with edge of FIG. 4.

A system 1 (FIG. 1) for arranging or removing a screen 2 some distance above crop 3 comprises supports 4 which rest on vertical columns 5 and on which beams or gutters 6 rest in transverse direction. The present embodiment relates particularly to (a part of) a greenhouse; the wall panels and roof panels and further construction are not shown in the figure however, as these are already per se known, which is also the case for embodiments wherein the screen is arranged above outdoor crops and/or outdoor products. Situated on tubular supports 4 are profiles 7 for guiding the edge 8 (FIG. 2) arranged on screen 2. The edge of this screen consists of a flexible cord 10 and beads 11, which are manufactured from for instance steel or plastic and fixed to the cord in moulded or clamped manner. This bead cord is arranged fixedly or sealed on the screen cloth, foil, wire mesh or netting by means of for instance a perforated hem strip, wherein the beads protrude through the perforation holes. Beads 11 can likewise be clamped or moulded on a hem strip of the screen. Also running inside the profile is a chain or a pull cable 12 of for instance steel or plastic, which materials can both provide the required tensile force, having beads 13 connected thereto in moulded or clamped manner, wherein this cable 12 can perform a reciprocating movement inside profile 7. The pitch of beads 13 corresponds with the pitch of beads 11 of thickened edge 8 and forms as it were an endless gear rack, which runs in the same cavity of profile 7 and engages on beads 11 of thickened edge 8. On the outer end of profile 7, at a position where the profile is curved toward the ground (FIG. 1), the thickened edge 8 of screen 2 can now be inserted as desired into the profile by opening clamps 17 (FIG. 2) such that insertion takes place easily. On the upper side of the profile are arranged channels 18 which enable arranging of pull cable 12 in profile 7 by placing a tool through these channels (FIG. 2). Pulling in and out of the cloth/foil takes place by moving pull cable 12 inside profile 7. Pull cable 12 is driven by a wheel 14 (a, b) which is provided with nest-like recesses which engage on beads 13 of pull cable 12 owing to the corresponding form. On the other outer end of the profile is situated a reversing wheel 25 (FIG. 2). In order to guide pull cable 12 properly in profile 7 there are additional wheels 15 arranged close to the entrances to this profile. After inserting edge 8 in clamps 17, these clamps are closed, whereafter the pulling mechanism 24 comes into operation to pull the edges of screen 8 into profiles 7. For this purpose this mechanism 24 consists of a motor 21 which transmits power to wheels 14 (a, b) by means of a shaft 22, wherein a gearbox 23, which enables switching of the transmission from a wheel 14a to another available wheel 14b, can be placed between shaft 22 and wheels 14 (a or b) as desired (FIG. 3). In this manner it is possible to use a plurality of profiles with a single drive mechanism. By moving one set of the wheels 14a or 14b the screen is now pulled out of the mobile basket 19 (FIG. 3) in which this screen lies folded in zigzag manner and which enables easy displacement of the screen. The screen can also be situated in rolled-up state on a roll 20, which is likewise mobile. It is thus possible in simple manner to arrange a screen in profile 7 from the ground floor, wherein this screen is pulled high up in the greenhouse and wherein the space below this screen can be completely screened by arranging this screen.

Profiles 7 are for instance fixed to supports 4 by means of clips 16 (FIG. 2) which can for instance be manufactured from steel and/or plastic, and which clips can be placed at a mutual distance to clamp the profile fixedly to support 4. Profile 7 herein runs over a determined length along the support to a position where screening is necessary (FIG. 1).

In a further preferred embodiment relating to open air applications above fruit or other cultures and crops, supports with profiles thereon for guiding the screen edge are supported by vertical columns, wherein screens with different properties connect to each other during replacement. If a rain or cold excluding screen, foil or cloth is removed from the profiles, a bird and/or insect repelling mesh can thus be simultaneously pulled in to repel birds and insects such as for instance lice and/or thrips, while still creating an outdoor climate herein. For repelling insects in greenhouses and foil tunnels, opened windows in the roof and in the vertical walls are screened off with wire mesh. Using the above described system there is the possibility of pulling an insect-repelling screen into the profiles to repel insects at those periods when this is necessary. The windows thus remain free of wire mesh, whereby the air supply in open position remains good and the insects are prevented from entering by means of the wire mesh pulled into the profiles in the greenhouse or tunnel. Rapid insertion of the wire mesh is possible, wherein this wire mesh can also be removed rapidly for cleaning or for exchange with another screen having for instance different mesh openings.

In a second embodiment the outer ends of the profiles, which in the first embodiment are curved (FIG. 1), are provided with wheels. A first wheel 30 guides cable 12 together with cord 10 in a first direction and a second wheel 32 guides cable 12 in an opposite direction. Wheels 30 and 32 have a diameter in the order of 90 mm. A reversing wheel 25 or a drive wheel 34 is arranged on the outer ends of a guide profile 48. Reversing wheel 25 is a smooth wheel (FIG. 2) and drive wheel 34 is a toothed wheel with grooves in the teeth in which the cable can fall (FIG. 4). Bead-like bodies 36 on cable 12 and on the edge of the screen consist of cylinders 38 with raised edges 40 on both ends. The bodies 42, which are arranged on the cable on the edge of the screen and which are shown more clearly in FIG. 6, consist of a cylindrical middle part 44 with raised edges 46 on both ends. A zip fastening 46 is optionally arranged in screen 2 with closure 47 close to cable 10.

Similarly to the first embodiment, aluminum profiles 48 are arranged on the support on both sides, which profiles are described with reference to FIG. 5 and which are clamped against support 4 with stainless steel clamps (FIG. 4).

Profiles 48 are symmetrical and extend along support 4 in longitudinal direction and over a random length (FIG. 5). Arranged on the top and bottom in cross-section are curved edges 52 with recess 54 in the side remote from the support. Oval cavities 56 are open on one side and enclosed by walls 58, 60 on the top and bottom side and separated by wall 62. Middle wall 62 ends in standing edges 64. Placed on an upper side of support 4 is a saddle 66 with standing edges 68, around which the edges 52 of the profiles fall.

Clamp 50 has sufficient clamping force and falls at the ends into recesses 54 (FIG. 5). Owing to the symmetry a clamp 50 can be arranged on both the underside and the upper side of the profiles. The gaps between support 4 and profiles 48 are sealed against air flow and/or light by strips 70 of rubber or a suitable plastic.

A lead-in part 72 is funnel-shaped and consists of a fixed part 74 and a curved plate 76 hingedly connected to part 74 (FIG. 6). Cable 10 with bodies 42 can be carried into lead-in part 72 by folding open plate 76, wherein bodies 42 drop between bodies 36 of cable 12. A good fit herein reduces the friction between bodies 36 and 42. After folding plate 76 down, the cable 12 is moved upward (FIG. 6), wherein the edge of screen 2 is coupled as a zip fastening to cable 12 in lead-in part 72.

In a further embodiment (not shown) profiles 7 or 48 are embodied integrated with supports 4 (FIGS. 1 and 4) or with gutters 6 (FIG. 1).

A zip fastening 46 is optionally arranged in the screen. Cable 12 with bead-like bodies 13 is herein omitted. Profile 48 contains cavities 56 in which circulate only bead-like bodies 11 connected to zip fastening edge 78, driven by drive wheel 34 and reversed by reversing wheel 25. Screen 2 is connected to another zip fastening edge. The coupling and uncoupling of the two zip fastening edges takes place by means of the closure 47 situated at a fixed position in the vicinity of drive wheel 34.

If screen 2 is connected to cable 12 in above stated manner, cables 10 and 12 are moved through openings 56, wherein owing to the force of gravity the screen 2 falls against standing edge 64 to seal the space therebetween. cable 12 runs in a lower opening 56 in opposite direction back from reversing wheel 25 or drive wheel 34.

The above described preferred embodiments of a system for arranging or removing a screen above a ground provide a high convenience of use and safety, wherein arranging and removing is less labour-intensive since a screen can be arranged easily from ground floor level, and ensures a high light output since the screen can be removed easily and does not remain permanently present in folded or rolled-up state at the top of the greenhouse.

The present invention is not limited to the above described preferred embodiments thereof; the rights sought are defined by the following claims, within the scope of which many modifications can be envisaged.

1. System for arranging or removing a screen some distance above a ground, particularly provided with crops, comprising:
one or more supports extending at least partly at the distance above the ground, wherein the supports are provided with guide means;
a screen with edge suitable for being guided in or along the guide means of the supports; and
pulling means which are arranged on at least one side of the guide means and which can be mounted releasably on the edge of the screen, in order to pull the screen along the supports into a position substantially screening the ground or into a position leaving the ground clear.

2. System as claimed in claim 1, wherein the guide means comprise one or more profiles for guiding the edge of the screen.

3. System as claimed in claim 1 or 2, wherein the edge mounted on the screen comprises bead-like bodies.

4. System as claimed in any of the foregoing claims, wherein the edge of the screen consists of bead-like bodies of plastic or metal which are moulded or clamped on a wire or cord.

5. System as claimed in any of the foregoing claims, wherein the pulling means comprise a cable or chain provided with bead-like bodies for pulling in and out of the screen, wherein the pitch of the bead-like bodies on the cable corresponds with the pitch of the bead-like bodies of the edge.

6. System as claimed in claim 5, wherein the cable or chain is of steel and/or synthetic material.

7. System as claimed in any of the claims 3-6, also comprising one or more wheels with nests for driving the cable or chain, wherein the bead-like bodies on the cable drop into the nests of the wheels.

8. System as claimed in claim 7, wherein the wheels are driven in pairs via a common shaft.

9. System as claimed in any of the foregoing claims, wherein the screen is strengthened with steel wires and/or wires of synthetic material.

10. System as claimed in any of the foregoing claims, also comprising mobile baskets and/or rolls for stowing and/or displacing the screens.

11. System as claimed in any of the claims 5-10, also comprising one or more wheels with teeth for driving the cable or chain, wherein the bead-like bodies on the cable drop between the teeth of the wheels.

12. System as claimed in any of the foregoing claims, wherein the screen comprises a zip fastening.

13. System as claimed in any of the claims 1-12, wherein the guide means are arranged on the supports with clamps.

14. System as claimed in any of the claims 1-13, wherein the guide means comprise a lead-in part which is funnel-shaped and which can be folded at least partially open.

15. System as claimed in any of the claims 1-14, wherein the guide means comprise wheels with grooves for guiding the cable or chain and/or the edge of the screen.

16. Greenhouse, glasshouse, screen-covered hall or rain screen provided with a system as claimed in one or more of the claims 1-15.

17. Greenhouse or glasshouse as claimed in claim 16, wherein two or more guide means for guiding two or more screens are arranged on a common support.

18. Profile evidently suitable as guide means for a screen in the system as claimed in one or more of the claims 1-15.

19. Screen provided with a thickened edge and evidently suitable for a system as claimed in one or more of the claims 1-15.
